(19) United States
(12) Patent Application Publication
(10) Pub. No.: US 2024/0367990 A1
(43) Pub. Date: Nov. 7, 2024

(54) PROCESSING HARD ROCK LITHIUM MINERALS OR OTHER MATERIALS TO PRODUCE BOTH LITHIUM CARBONATE AND LITHIUM HYDROXIDE

(71) Applicant: Frontier Lithium Inc., Val Caron (CA)

(72) Inventor: Naizhen Cao, Val Caron (CA)

(73) Assignee: Frontier Lithium Inc., Val Caron, ON (CA)

(21) Appl. No.: 18/686,519

(22) PCT Filed: Aug. 27, 2022
(86) PCT No.: PCT/IB2022/058032

§ 371 Date: Feb. 26, 2024

Related U.S. Application Data
(60) Provisional application No. 63/237,996, filed on Aug. 27, 2021.

(51) Int. Cl. C01D 15/08; C01D 15/02; C01F 11/46; H01M 6/52; H01M 10/54

(52) U.S. Cl. CPC C01D 15/08; C01D 15/02; C01F 11/46; H01M 6/52; H01M 10/54

(57) ABSTRACT

Methods are provided for processing a lithium-containing material, such as spodumene, whereby a lithium sulfate solution derived from the material is reacted with sodium hydroxide to produce an intermediate solution comprising a first and second portion comprising lithium hydroxide and sodium sulfate. Lithium hydroxide and sodium sulfate are produced from the first portion. Lithium carbonate and sodium sulfate are produced from the second portion by reacting the intermediate solution with carbon dioxide. The intermediate solution may also be subjected to freezing thereby separating the lithium hydroxide from the sodium sulfate, and the separated lithium hydroxide may be reacted with carbon dioxide to produce a lithium product comprising lithium carbonate. Sodium sulfate from these processes may be reacted with an alkali chemical to produce a byproduct and a sodium hydroxide reaction fluid. The reaction fluid circulated in a continuous closed-loop into the reaction system to produce LiOH/Na₂SO₄ intermediate solution.

### CROSS-REFERENCE

This application claims priority to U.S. Provisional Patent Application No. 63/237,996 filed on Aug. 27, 2021 (“PROCESSING HARD ROCK LITHIUM MINERALS OR OTHER MATERIALS TO PRODUCE BOTH LITHIUM CARBONATE AND LITHIUM HYDROXIDE”), which is entirely incorporated herein by reference.

### FIELD

The present disclosure relates to methods for processing hard rock lithium minerals and other lithium containing materials to produce both lithium carbonate (Li₂CO₃) and lithium hydroxide monohydrate (LiOH—H₂O).

### BACKGROUND

Electrically-powered vehicles and other machines are increasing in popularity due to market demand, regulatory requirements, and political desire to reduce fossil fuel consumption and greenhouse gas emissions. This transition requires economical production of large volumes of lithium materials for batteries.

Lithium carbonate (Li₂CO₃, or LC) and lithium hydroxide monohydrate (LiOH—H₂O, or LHM) are the two most important basic lithium materials for lithium battery production and for many other lithium related industries.

Lithium is extracted from two main lithium sources: liquid brine containing lithium; and hard rock deposits containing lithium such as spodumene. Spodumene is a pyroxene mineral consisting of lithium aluminum inosilicate (LiAl(SiCO₃)₂). The naturally-occurring low-temperature form α-spodumene is in the monoclinic system, and the high-temperature β-spodumene crystallizes in the tetragonal system. α-spodumene converts to β-spodumene at temperatures above 900° C.

To produce Li₂CO₃ and LiOH—H₂O from hard rock, the sulfuric acid process is the most reliable technology, and is therefore the mostly used process in current lithium industry.

FIG. 1 shows a prior art method for processing α-spodumene concentrate to produce Li₂CO₃. Solid α-spodumene concentrate is converted to β-spodumene by kiln calcination. Then β-spodumene is mixed with H₂SO₄ and subjected to acid roasting. Then the acid-roasted material is mixed with water in leaching tanks, where lithium and other metal impurities are leached into solution. Limestone powder (CaCO₃), lime (CaO) or hydrated lime (Ca(OH)₂), NaOH, Na₂CO₃ or any other reagent which can precipitate the impurities may be added to the solution to change the pH and remove the impurities. By solid/liquid (S/L) separation, leaching residue and impurity residue are separated, and a pregnant leach solution (PLS) is obtained. If necessary, an ion exchange (IX) circuit is further used to remove Ca and Mg impurities. By this purification, clean PLS solution comprising Li₂SO₄ is obtained. The purified Li₂SO₄-PLS solution is reacted with Na₂CO₃ to precipitate Li₂CO₃. The precipitated Li₂CO₃ is separated and dried as Li₂CO₃ product. If battery-grade product is desired, the wet Li₂CO₃ cake obtained is re-dissolved and further purified by CO₂ method as known in the art. The wet Li₂CO₃ obtained after filtration is dried to produce a final battery-grade Li₂CO₃ product. Usually, before final packing, there are magnetic impurity removal steps in some parts of the process and a micronizing step to reduce the size of Li₂CO₃ particles to a desired size, as well as, some evaporation steps to increase concentration of main compositions. The mother liquor from Li₂CO₃ solid/liquid separation goes to a Na₂SO₄ crystallization circuit to get rid of Na₂SO₄ solid from the process. The mother liquor and condensed water after Na₂SO₄ crystallization can be recycled to the process for re-use.

FIG. 2 shows a prior art method for processing α-spodumene concentrate to produce lithium hydroxide monohydrate LiOH—H₂O. The method is similar to the method of FIG. 1 for producing Li₂CO₃, with differences as follows. The purified Li₂SO₄-PLS is reacted with NaOH to produce mixed LiOH and Na₂SO₄ solution. By freezing treatment, a typical method used in current lithium industry and known in the art, Na₂SO₄ is separated from the solution in the form of Glauber's salt (Na₂SO₄-10H₂O). The Na₂SO₄-removed LiOH PLS solution is sent to crystallizer to produce a wet LiOH cake. The wet LiOH cake is dried to produce a final LiOH—H₂O product. If battery-grade product is desired, the produced wet LiOH cake is re-dissolved and subjected to secondary or tertiary crystallization, as required. The mother liquor and condensed water of LiOH crystallization is recycled to the process for re-use. In another stream, the Glauber's salt separated from the PLS is re-dissolved and the resulting Na₂SO₄ solution is sent to an evaporator for Na₂SO₄ crystallization. The mother liquor and condensed water of Na₂SO₄ crystallization are recycled to the process for re-use.

The processes of FIGS. 1 and 2 are directed to producing either Li₂CO₃ or LiOH—H₂O, but not both of them.

In general, the processes of FIGS. 1 and 2 produce up to more than 2 tons of Na₂SO₄ for 1 ton of Li₂CO₃ or LiOH—H₂O. This is problematic for many reasons. First, the Na₂SO₄ byproduct needs a special production plant for its crystallization, which requires a high capital investment. For example, up to $15 million USD of capital investment is required for a typical Na₂SO₄ crystallizer plant for a 20 KT Lithium Carbonate Equivalent (LCE) chemical plant. This significantly increases capital expenditure, and significantly lowers production profit. Second, evaporating water from the very large volume of Na₂SO₄ solution consumes a large amount of energy. Third, NaOH or Na₂CO₃ is consumed in the chemical conversion reaction from Li₂SO₄ solution to Na₂SO₄ byproduct. NaOH and Na₂CO₃ are higher value chemicals than Na₂SO₄, and therefore this impairs the economics of the process. Last, but not the least, the marketability of the Na₂SO₄ byproduct is limited. Use of Na₂SO₄ for the production of detergent powder accounts for more than 80% of the total market for Na₂SO₄, and this market is found mainly in Asian countries. This means that in countries outside of Asia, especially in North America and Europe, it will be economically prohibitive to produce lithium materials from hard rock with the conventional process as illustrated in FIGS. 1 and 2, despite the production of Na₂SO₄ as a byproduct and its transport to economically viable markets. Moreover, mining industries and many other industries also produce large volumes of Na₂SO₄, making for a supply-rich market of Na₂SO₄.

The processes of FIGS. 1 and 2 also produce CO₂ emissions, as a result of combustion of fossil fuels to produce heat for the calcination and acid-roasting steps. These CO₂ emissions may act as greenhouse gases that contribute to climate change.

The processes of FIGS. 1 and 2 also consume large amounts of NaOH and Na₂CO₃ as main reagents, and this adds to overall cost of the process.

Nonetheless, the conventional processes of FIGS. 1 and 2 are well proven and optimized for the production of Li₂CO₃ and LiOH—H₂O, by the conversion reaction of Li₂SO₄ with Na₂CO₃ or NaOH, respectively. It would therefore be desirable to maintain these conversion reactions, while improving upon the processes to address the aforementioned issues.

Accordingly, there is a need in the art for methods of processing spodumene or other lithium containing materials and solutions to produce both Li₂CO₃ and LiOH—H₂O, and allow for selective control over the amount of each such lithium product that is produced. It would also be desirable if such methods were to avoid or reduce production of the Na₂SO₄ byproduct. It would be desirable for such methods to increase the recovery of lithium produced by the method, significantly reduce the amount of required main or primary reagent or replace the main reagent with a more economical reagent, reduce energy inputs, and reduce CO₂ gas emissions relative to prior art methods. It would be desirable to use one reagent to produce both Li₂CO₃ and LiOH—H₂O. It would also be desirable if CO₂ from the flue gas from lithium plant can be utilized in the production of a lithium product.

### SUMMARY

In accordance with a broad aspect of the present disclosure, there is provided a method of processing a lithium-containing material to produce a lithium product, the method comprising the steps of: preparing an aqueous feed solution comprising lithium sulfate by reacting the lithium-containing material with sulfuric acid; reacting the feed solution with sodium hydroxide to produce a first intermediate solution comprising lithium hydroxide and sodium sulfate; producing the lithium product, wherein producing the lithium product comprises the sub-step(s) of: (i) separating a primary lithium product comprising the lithium hydroxide from a first portion of the first intermediate solution; or reacting a second portion of the first intermediate solution with carbon dioxide to produce a secondary lithium product comprising lithium carbonate.

In embodiments, in accordance with another broad aspect, the method of processing a lithium-containing material to produce a lithium product may comprise the steps of subjecting the first intermediate solution comprising lithium hydroxide and sodium sulfate to freezing, thereby separating the lithium hydroxide from the sodium sulfate; and reacting the carbon dioxide with lithium hydroxide to produce the secondary lithium product comprising lithium carbonate.

In accordance with a further broad aspect of the present disclosure, there is provided a method of processing an aqueous feed solution comprising lithium sulfate to produce a lithium product, the method comprising the steps of: reacting the aqueous feed solution with sodium hydroxide to produce a first intermediate solution comprising lithium hydroxide and sodium sulfate; wherein producing the lithium product comprises the sub-step(s) of: (i) separating a primary lithium product comprising the lithium hydroxide from at least a first portion of the first intermediate solution; or reacting a second portion of the first intermediate solution with carbon dioxide to produce a secondary lithium product comprising lithium carbonate.

In embodiments, in accordance with another broad aspect, the method of processing an aqueous feed solution comprising lithium sulfate to produce a lithium product may comprise the steps of subjecting the first intermediate solution comprising lithium hydroxide and sodium sulfate to freezing, thereby separating the lithium hydroxide from the sodium sulfate; and reacting the carbon dioxide with lithium hydroxide to produce the secondary lithium product comprising lithium carbonate.

In embodiments, the method may comprise a step of producing a second intermediate solution comprising sodium sulfate from the first intermediate solution.

In embodiments, the primary and secondary lithium products may be simultaneously produced.

In embodiments, the method may comprise a step of reacting the second intermediate solution comprising sodium sulfate with an alkali chemical to produce sodium hydroxide and a byproduct. In accordance with another broad aspect of the present disclosure, there is provided a method of processing a lithium-containing material to produce a first primary lithium product of lithium hydroxide and a secondary lithium product comprising lithium carbonate, the method comprising the steps of: preparing an aqueous feed solution comprising lithium sulfate by reacting the lithium-containing material with sulfuric acid; reacting the feed solution with sodium hydroxide to produce a first intermediate solution comprising lithium hydroxide and sodium sulfate; separating the primary lithium product comprising lithium hydroxide from a first portion of the first intermediate solution comprising lithium hydroxide and sodium sulfate; and reacting a second portion of the first intermediate solution with carbon dioxide to produce the secondary lithium product comprising lithium carbonate.

In embodiments, in accordance with another broad aspect, the method of processing a lithium-containing material to produce to produce a first primary lithium product of lithium hydroxide and a secondary lithium product comprising lithium carbonate may comprise the steps of subjecting the first intermediate solution comprising lithium hydroxide and sodium sulfate to freezing, thereby separating the lithium hydroxide from the sodium sulfate; and reacting the carbon dioxide with lithium hydroxide to produce the secondary lithium product comprising lithium carbonate.

In accordance with a further broad aspect of the present disclosure, there is provided a method of processing an aqueous feed solution comprising lithium sulfate to produce a first primary lithium product of lithium hydroxide and a secondary lithium product comprising lithium carbonate, the method comprising the steps of: reacting the feed solution with sodium hydroxide to produce a first intermediate solution comprising lithium hydroxide and sodium sulfate; separating the primary lithium product comprising lithium hydroxide from a first portion of the first intermediate solution comprising lithium hydroxide and sodium sulfate; and reacting a second portion of the first intermediate solution with carbon dioxide to produce the secondary lithium product comprising lithium carbonate.

In embodiments, in accordance with another broad aspect, the method of processing an aqueous feed solution comprising lithium sulfate to produce to produce a first primary lithium product of lithium hydroxide and a secondary lithium product comprising lithium carbonate may comprise the steps of subjecting the first intermediate solution comprising lithium hydroxide and sodium sulfate to freezing, thereby separating the lithium hydroxide from the sodium sulfate; and reacting the carbon dioxide with lithium hydroxide to produce the secondary lithium product comprising lithium carbonate.

In embodiments, the alkali chemical may comprise calcium hydroxide and the byproduct may comprise calcium sulfate; the alkali chemical may comprise ammonium hydroxide and the byproduct may comprise ammonium sulfate; the alkali chemical may comprise comprises barium hydroxide and the byproduct may comprise barium sulfate; or the alkali chemical may comprise potassium hydroxide and the byproduct may comprise potassium sulfate.

In embodiments, the method may comprise a step of producing the second intermediate solution, wherein the second intermediate solution may comprises the sub-steps of: separating decahydrate of sodium sulfate from the portion of the first intermediate solution;

and dissolving the separated decahydrate of sodium sulfate in water to produce the second intermediate solution comprising sodium sulfate.

In embodiments, the carbon dioxide may be separated from a flue gas produced by combustion of a fossil fuel used to produce heat for sulfuric acid roasting of a mineral used to prepare the feed solution, or for a calcination process of a mineral used to prepare the feed solution, or for generating steam for use in the method.

In embodiments, the lithium-containing material may comprise a mineral, such as spodumene, and reacting the lithium-containing material with sulfuric comprises may comprise sulfuric acid roasting the mineral to prepare an acid-roasted mineral.

In embodiments, before reacting the mineral with sulfuric acid, the method may comprise the step of subjecting the mineral to a calcination process for phase conversion of the mineral.

In embodiments, the lithium-containing material may comprise low grade lithium carbonate, other lithium containing hard rocks, non-hard rock lithium containing minerals, or material from lithium battery recycling.

Additional aspects, advantages and features of the present invention will become more apparent upon reading of the following non-restrictive description of preferred embodiments which are exemplary and should not be interpreted as limiting the scope of the invention.

### BRIEF DESCRIPTION OF THE DRAWINGS

In the drawings, like elements may be assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention.

Further features and advantages of the present disclosure will become apparent from the following detailed description, taken in combination with the appended drawings, in which:

FIG. 1 is a flow chart for a prior art method for processing α-spodumene concentrate to produce a Li₂CO₃ lithium product, and Na₂SO₄ byproduct.

FIG. 2 is a flow chart for a prior art method for processing α-spodumene concentrate to produce a LiOH—H₂O lithium product, and Na₂SO₄ byproduct.

FIG. 3 is a flow chart for an embodiment of a method of the present invention for processing α-spodumene concentrate and flue gas to produce a LiOH—H₂O primary lithium product, a Li₂CO₃ secondary lithium product, a CaSO₄ byproduct by reaction of a Na₂SO₄ intermediate product with an alkali chemical, and a NaOH reaction fluid that is circulated in the closed loop and re-used in the method.

FIG. 4 represents a flow chart for another embodiment of a method of the present invention for processing α-spodumene concentrate and use of flue gas to produce a LiOH—H₂O primary lithium product, a Li₂CO₃ secondary lithium product, a CaSO₄ byproduct by reaction of a Na₂SO₄ intermediate product with an alkali chemical, and a NaOH reaction fluid that is circulated in the closed loop and re-used in the method. FIG. 4 is similar to FIG. 3 in most parts except that no Na₂SO₄ mother liquor stream is produced in Li₂CO₃ circuit.

### DETAILED DESCRIPTION OF EMBODIMENTS

### Overview.

Example methods are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. The example embodiments described herein are not meant to be limiting. It will be readily understood that certain aspects of the disclosed methods can be arranged and combined in a wide variety of different configurations, all of which are contemplated herein.

The disclosure relates to processing a lithium-containing materials such as hard rock to produce either lithium carbonate (Li₂CO₃) or lithium hydroxide monohydrate (LiOH), or both of them. Any term or expression not expressly defined herein shall have its commonly accepted definition understood by a person skilled in the art.

The present disclosure provides a method of processing a material containing lithium, such as hard rock lithium minerals like α-spodumene, to produce a primary lithium product comprising lithium hydroxide monohydrate (LiOH—H₂O), a secondary lithium product comprising lithium carbonate (Li₂CO₃), and a sulfate byproduct such as calcium sulfate (CaSO₄) by the conversion of a sodium sulfate (Na₂SO₄) intermediate product in the presence of an alkali chemical. It will be understood that the terms “primary lithium product” and “secondary lithium product” are used for convenience to distinguish the products, and do not limit the present invention in terms of the relative amounts that are produced of each product, or the order by which they each can be produced. The amount of each product may be selectively varied.

In a broad aspect of the present disclosure, there is provided a method of processing a material containing lithium, such as hard rock lithium minerals like α-spodumene, to produce a primary lithium product comprising lithium hydroxide monohydrate (LiOH—H₂O), a secondary lithium product comprising lithium carbonate (Li₂CO₃), and a sulfate byproduct such as calcium sulfate (CaSO₄) by converting sodium sulfate (Na₂SO₄) as an intermediate product, the method comprising the steps of: (i) preparing and providing an aqueous feed solution comprising lithium sulfate (Li₂SO₄) by reacting the lithium-containing material with sulfuric acid (H₂SO₄); (ii) reacting the aqueous feed solution with some base reagents, such as, sodium hydroxide (NaOH), sodium carbonate (Na₂CO₃), limestone powder (CaCO₃), lime (CaO), hydrated lime (Ca(OH)₂), water or other suitable reagents, and subjecting the aqueous feed solution to a solid/liquid separation to obtain a purified feeding solution containing Li₂SO₄; (iii) reacting the purified feeding solution with NaOH to produce a first intermediate solution comprising lithium hydroxide (LiOH) and sodium sulfate (Na₂SO₄), wherein said first intermediate solution may be further divided into a first and a second portion; (iv) separating the primary lithium product comprising lithium hydroxide (LiOH) from the first portion of the first intermediate solution, and producing a second intermediate solution comprising sodium sulfate (Na₂SO₄) from the first portion of the first intermediate solution; or/and (v) alternatively or in parallel, reacting the second portion of the first intermediate solution with a secondary reagent comprising carbon dioxide (CO₂) to produce a secondary lithium product comprising lithium carbonate (Li₂CO₃) and a third intermediate solution comprising sodium sulfate (Na₂SO₄); and (vi) reacting the second intermediate solution comprising sodium sulfate (Na₂SO₄), or the third intermediate solution comprising sodium sulfate (Na₂SO₄), or both of them, with an alkali chemical to produce sodium hydroxide (NaOH) and a byproduct such as calcium sulfate (CaSO₄); or/and optionally (vii) repeating steps (ii) through (vi), wherein the sodium hydroxide (NaOH) produced in step (vi) is used and recycled when repeating step (ii).

In an embodiment, the Li₂SO₄ feed solution is derived from low grade lithium carbonate product, which can be obtained from the brine lithium industry. The low grade lithium carbonate may be reacted with H₂SO₄ to produce a Li₂SO₄ feed solution.

In another embodiment, the Li₂SO₄ feed solution is derived from used battery materials, which can be obtained from the battery recycling industry. The used battery materials may be reacted with H₂SO₄ and be leached to produce Li₂SO₄ feed solution.

In another embodiment, the Li₂SO₄ feed solution can be derived from lithium extracted from hard rock minerals, other than spodumene, such as petalite, lepidolite, zinnwaldite, amblygonite, and eucryptite, and non-hard rock minerals such as hectorite, lithium clays, jadarite and so on. Lithium can be extracted from these minerals using a H₂SO₄ acid process similar to extracting lithium from spodumene to produce the Li₂SO₄ feed solution. Depending on the mineral, calcination, i.e. phase conversion, and/or acid roasting at high temperatures of the mineral may or may not be required.

It will be understood that the methods may be performed on a batch basis (i.e., the steps are performed once in sequence for a batch of α-spodumene concentrate), or on a continuous basis (e.g., the steps are performed continuously and simultaneously as further α-spodumene concentrate is continuously processed to continuously produce further feed solution, to continuously produce further primary lithium product and secondary lithium product).

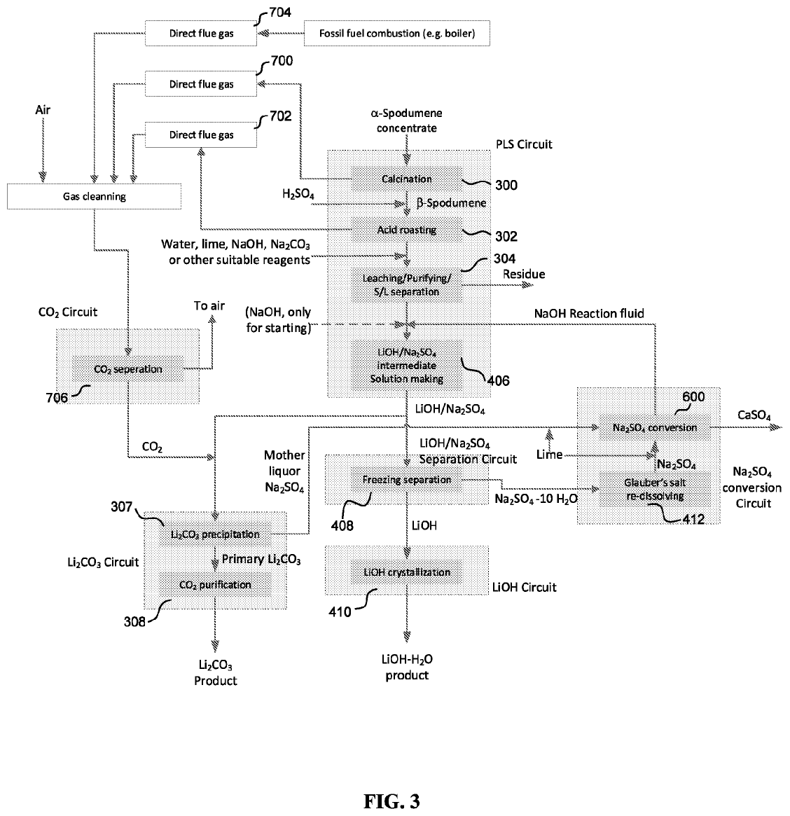

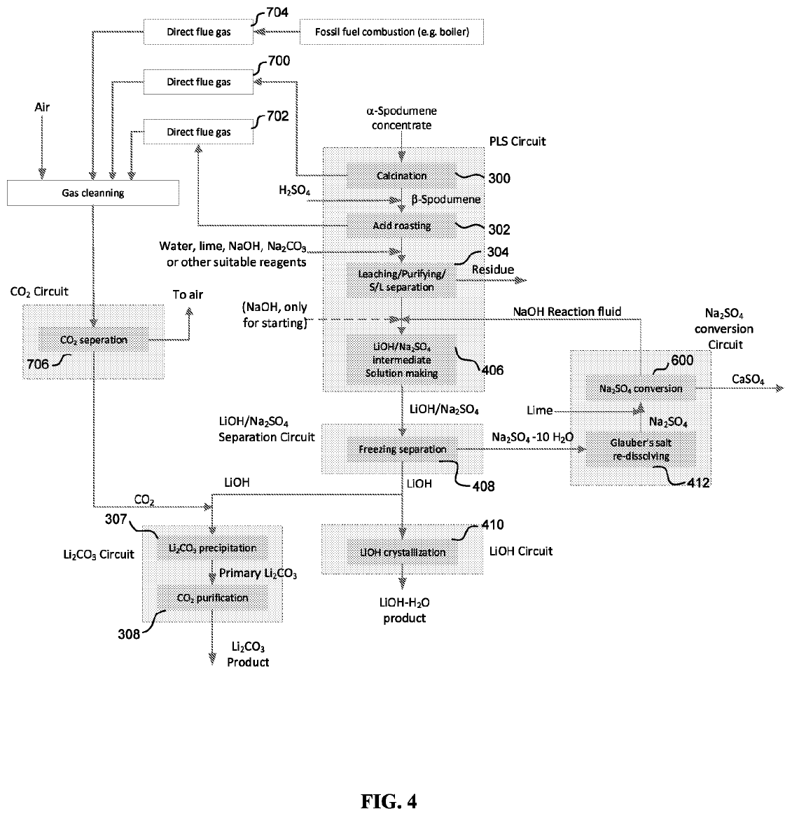

FIG. 3 and FIG. 4, as described below in more details, represent flow charts showing steps of different embodiments of the methods. With the benefit of such flow charts, the person skilled in the art will be able to carry out processes of the described method using equipment known in the art, such as rotary kilns, various reactors, tanks, thickener, centrifuge, various filters, various driers, ion exchange, water treatment equipment, crystallizers, and other separation equipment, heating equipment, and so forth, as may be needed.

The following examples provide an embodiment of the method of the present disclosure, as it may applied to processing α-spodumene concentrate, such examples are not limitative, and shall not be interpreted, as limiting the methods described herein.

Example no. 1: combined production of LiOH—H₂O as primary lithium product, Li₂CO₃ as a secondary lithium product by capture and conversion or sequestration of CO₂ from flue gas, as well as, the production of CaSO₄ byproduct by the reaction of an intermediate byproduct Na₂SO₄ with an alkali chemical (Ca(OH)₂), and a NaOH reaction fluid that may be recirculated in a closed-loop and re-used in the method as described herein.

FIG. 3 represents a flow chart of an embodiment of a method of the present invention for processing α-spodumene concentrate to produce a LiOH—H₂O primary lithium product, and a Li₂CO₃ secondary lithium product by capturing and converting or sequestring CO₂ from a flue gas. In this example, second and third Na₂SO₄ intermediate solution is converted by a reaction with an alkali chemical of Ca(OH)₂ to produce a final byproduct of solid CaSO₄, and a solution of NaOH. The NaOH may be re-used as a “reaction fluid” that is circulated inside a closed-loop circuit of the present method for further production of the primary lithium product (LiOH—H₂O) and the secondary lithium product (Li₂CO₃). The as illustrated may be continuously performed. The term “NaOH reaction fluid”, as used herein, distinguishes the NaOH produced and re-used inside the closed-loop circuit from an initial input of NaOH that is used when the method is started. As the method is continuously performed, the NaOH reaction fluid is again regenerated, and circulated in the closed-loop circuit, thus reducing or avoiding the need for an input of additional NaOH during the continuous and further production of LiOH—H₂O and Li₂CO₃.

Although Ca(OH)₂ is used as the alkali chemical in this example, it will be understood that other alkali chemicals of the group consisting of ammonium hydroxide (NH₄OH), barium hydroxide (Ba(OH)₂), potassium hydroxide (KOH) or mixtures of any of the foregoing, may be used instead of Ca(OH)₂.

The reaction of these other alkali chemicals with Na₂SO₄ will produce different byproducts, as noted in Table 1 below.

TABLE 1

| Alkali chemical | Byproducts from reaction with Na₂SO₄ |
|---|---|
| ammonium hydroxide | ammonium sulfate ((NH₄)₂SO₄) and sodium |
| (NH₄OH) | hydroxide (NaOH) |
| barium hydroxide | barium sulfate (BaSO₄) and sodium hydroxide |
| (Ba(OH)₂) | (NaOH) |
| calcium hydroxide | calcium sulfate (CaSO₄) and sodium hydroxide |
| Ca(OH)₂ | (NaOH) |
| potassium hydroxide | potassium sulfate (K₂SO₄) and sodium |
| (KOH) | hydroxide (NaOH) |

As shown in FIG. 3, in embodiments, the steps of the method may be conceptualized as being parts of a PLS circuit, a LiOH/Na₂SO₄ separation circuit, a LiOH circuit, a Na₂SO₄ conversion circuit, a Li₂CO₃ circuit, and a CO₂ circuit, as described below.

### Pregnant Leach Solution (PLS) Circuit.

A purpose of the PLS circuit may be to produce an intermediate solution comprising a mixture of LiOH and Na₂SO₄, denoted LiOH/Na₂SO₄, that is used in downstream steps of the method. In embodiments as illustrated in FIG. 3, the PLS circuit includes steps 300, 302, 304, and 406.

At step 300, solid α-spodumene concentrate is converted to β-spodumene by calcination in a rotary kiln. Calcination is typically performed at temperatures of above 900° C. to convert α-spodumene to β-spodumene, but the present invention is not limited by a particular temperature.

At step 302, the produced β-spodumene is mixed with sulfuric acid (H₂SO₄) and subjected to acid roasting. Roasting is typically performed at temperatures of about 250° C. to form water soluble lithium sulfate (Li₂SO₄), but the present invention is not limited by a particular temperature.

In the steps 300 and 302, the heat required by kiln calcination and acid roasting is produced by combustion of fossil fuels in the current lithium extraction industry. This produces flue gases, including CO₂ gas, which may be diverted for use in the process as described below, rather than emitted into the atmosphere.

At step 304, the acid-roasted material is mixed with water in leaching tanks where lithium and other metal impurities are leached into solution. For solution purification, usually, limestone powder (CaCO₃), lime (CaO) or hydrated lime (Ca(OH)₂), NaOH, Na₂CO₃ or any other reagent which can precipitate impurities is or are added into the solution to change the pH and remove impurities and the over dosed SO₄₂-in acid roasting. By solid/liquid (S/L) separation, leaching residue and impurity residue are separated and PLS (pregnant leach solution) solution is obtained. If necessary, an ion exchange (IX) circuit is further used to remove Ca and Mg impurities. By this purification, clean PLS solution comprising Li₂SO₄ is obtained. Step 304 results in the production of aqueous solution comprising lithium sulfate (Li₂SO₄), which solution is considered to be an example of a “feed solution” in the present invention. Some evaporation steps to increase concentration of main compositions may be used during this feed solution making step, as required.

As step 406, NaOH is added to the PLS solution comprising Li₂SO₄. The Li₂SO₄ PLS reacts with NaOH to form a solution of a mixture of LiOH and Na₂SO₄, as shown below in Eqn. 1. The NaOH may be considered to be an example of a “reaction fluid” in the present invention, and the mixed Na₂SO₄ and LiOH solution may be considered to be a “first intermediate solution” in the present invention.

Li₂SO_{4(aq)}+2 NaOH_{(aq)}→Na₂SO_{4(aq)}+2 LiOH_{(aq)} (Eqn. 1)

LiOH/Na₂SO₄ Separation Circuit.

A purpose of the LiOH/Na₂SO₄ Separation Circuit is to process the mixed LiOH and Na₄SO₄ solution resulting from the PLS circuit to produce the LiOH PLS solution and separate Na₂SO₄ from the solution. In embodiments, and as illustrated in FIG. 3, the LiOH/Na₂SO₄ Separation Circuit includes step 408.

At step 408, the solution resulting from PLS circuit may be subjected to freezing treatment by lowering its temperature between 0° C. to −15° C. The solubility of LiOH at freezing temperatures is greater than the solubility of Na₂SO₄ at freezing temperatures. Thus, as a result of the freezing treatment, Na₂SO₄ is separated from solution in the form of the decahydrate of sodium sulfate (Na₂SO₄-10H₂O), which is known in the art as a Glauber's salt.

### LiOH Circuit.

A purpose of the LiOH circuit is to process the LiOH solution resulting from the LiOH/Na₂SO₄ Separation Circuit to produce the LiOH—H₂O primary lithium product. In embodiments, as illustrated in FIG. 3, the LiOH Circuit includes step 410.

At step 410, the Na₂SO₄-removed LiOH PLS solution resulting from step 408 is subjected to crystallization to produce a wet LiOH cake.

The wet LiOH cake is dried to produce a final LiOH—H₂O product. If battery-grade product is desired, the produced wet LiOH cake can be re-dissolved and subjected to secondary or tertiary crystallization, as required. Usually, magnetic impurity removal in some parts of process and/or micronizing before packaging may also be performed for battery grade product.

Na₂SO₄ Conversion Circuit.

A purpose of the Na₂SO₄ conversion circuit is to process the Glauber's salt separated from the LiOH solution in step 408, and the mother liquor comprising Na₂SO₄ separated from step of 307 in the Li₂CO₃ Circuit, to produce CaSO₄ as a byproduct. Another purpose of the Na₂SO₄ conversion circuit is to produce further NaOH reaction fluid, which is used to repeatedly react with further Li₂SO₄ PLS in step 406 of the PLS circuit, as the method continues to be performed. In the method, the NaOH reaction fluid allows the LiOH conversion reaction in step 406 of the PLS Circuit to continue and NaOH is so recycled back into the processing method.

The skilled in the art would appreciate that, the initial input of NaOH to start the method is effectively not consumed, because it is regenerated in the Na₂SO₄ conversion Circuit as the NaOH reaction fluid.

In embodiment, as illustrated in FIG. 3, the Na₂SO₄ conversion circuit may include steps 412 and 600.

At step 412, the Glauber's salt that is produced from the freezing separation process of step 408 is re-dissolved in water to produce a solution of Na₂SO₄. This may be considered to be a “second intermediate solution” of the present invention.

At step 600, the solution of Na₂SO₄ resulting from step 412 or the “second intermediate solution” is mixed with an alkali chemical, for example, with hydrated lime Ca(OH)₂ so that the dissolved Na₂SO₄ and the Ca(OH)₂ react to convert the Na₂SO₄ to CaSO₄ and NaOH, as illustrated by the following equation:

Na₂SO_{4(aq)}+Ca(OH)_{2(aq)}→CaSO₄₍ₛ₎↓+2NaOH_{(aq)} (Eqn. 2)

As noted above with reference to Table 1, different alkali chemicals may be used instead of Ca(OH)₂ to produce NaOH and other sulfate byproducts, such as, but not limited to ammonium sulfate ((NH₄)₂SO₄), barium sulfate (BaSO₄), calcium sulfate (CaSO₄) and potassium sulfate (K2SO₄).

At step 600, a second input stream of a mother liquor comprising Na₂SO₄ solution from step 307 of Li₂CO₃ circuit may also be mixed with hydrated lime, and converted to CaSO₄ and NaOH, in accordance with Eqn. 2.

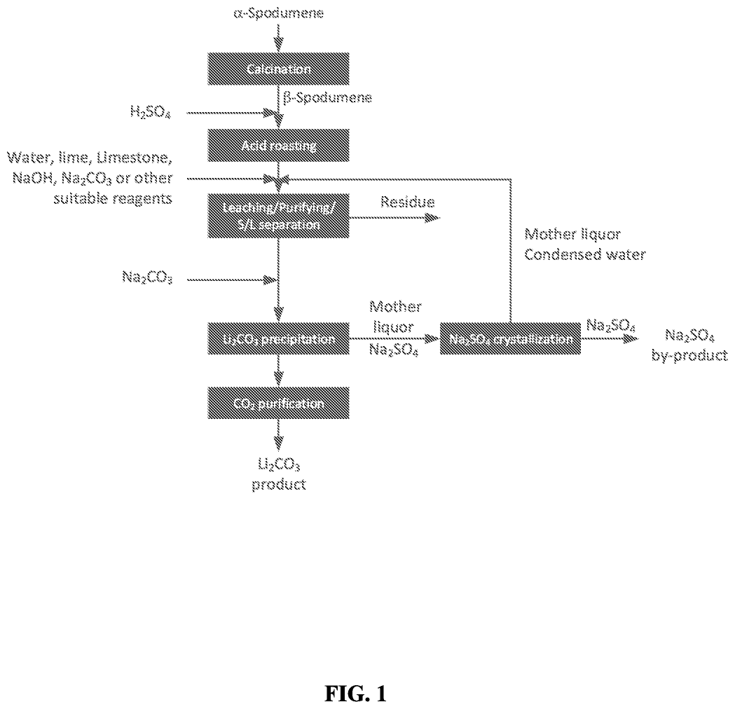

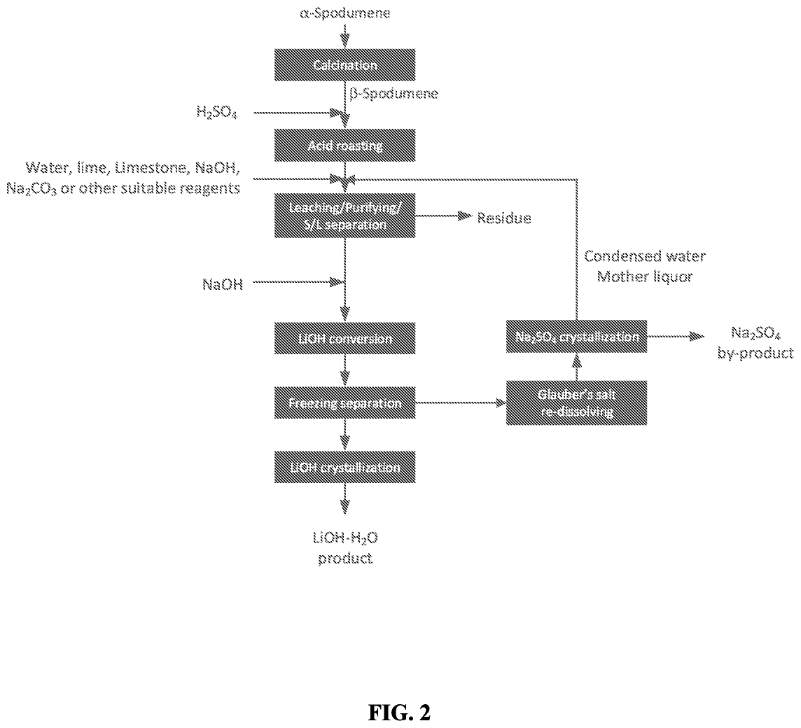

In comparison with the prior art process shown in FIG. 1 and FIG. 2, a skilled in the art would appreciate that the method as shown in FIG. 3 has several advantages, such as, but not limited to, a crystallization circuit for treating the Na₂SO₄ may be avoided or at least be reduced in capacity, thus reducing its associated capital and operating cost; in comparison with Na₂SO₄, CaSO₄ typically has a higher market value and different industrial application; and also CaSO₄ may be more conveniently handled than Na₂SO₄.

A portion or all of the NaOH may be sold to market as a product. In addition or in alternative, a portion or all of the NaOH may be re-introduced and recycled back into the process for use in the PLS purification process of step 304. In addition or in alternative, a portion or all of the NaOH may be re-introduced to the process and repeatedly used as “reaction fluid” in the LiOH/Na₂SO₄ Intermediate Solution making process of step 406. A skilled in the art would appreciate that this aspect is particularly significant because it means that only an initial amount of NaOH needs to be supplied as a reagent to start the process in the first instance for performing step 406. As step 406 is performed continuously, it is no longer necessary to supply additional NaOH. Rather, the NaOH can be sourced from step 600 and re-used or recycled back into the method. That is, while the NaOH is consumed in the PLS circuit (see Eqn. 1), it is regenerated in the Na₂SO₄ conversion circuit.

Li₂CO₃ Circuit

A purpose of the Li₂CO₃ circuit is to process the mixed LiOH/Na₂SO₄ solution resulting from step 406 to produce the Li₂CO₃ secondary lithium product. In embodiments, as illustrated in FIG. 3, the Li₂CO₃ circuit includes steps 307 and 308.

At step 307, the LiOH solution resulting from step 406 is reacted with CO₂ produced from the CO₂ circuit (described below), as follows. The CO₂ dissolves and reacts with the hydroxide ions (OH⁻) to produce bicarbonate ions (HCO₃⁻) in accordance with Eqn. 3a. The bicarbonate ions (HCO₃⁻) react with hydroxide ions (OH⁻) to produce carbonate ions (CO₃²⁻) and water (H₂O), in accordance with Eqn. 3b. The carbonate ions (CO₃²⁻) react with lithium ions to produce the Li₂CO₃ as a lithium primary product, in accordance with Eqn. 3c.

CO_{2(aq)}+OH⁻_{(aq)}→HCO₃⁻_{(aq)} (Eqn. 3a)

HCO₃⁻_{(aq)}+OH⁻_{(aq)}→CO₃²⁻_{(aq)}+H₂O^{(l)} (Eqn. 3b)

2Li⁺_{(aq)}+CO₃²⁻_{(aq)}→Li₂CO₃₍ₛ₎↓ (Eqn. 3c)

Thus, the overall process of converting the LiOH to Li₂CO₃ in accordance with step 307 is as follows.

2LiOH_{(aq)}+CO_{2(g)}→Li₂CO₃₍ₛ₎←+H₂O_{(aq)} (Eqn. 4)

The sodium sulfate Na₂SO₄ solution resulting from step 307 may be considered a “third intermediate solution” of the present disclosure, and separated as a mother liquor from the precipitated Li₂CO₃. It will be understood that the term “third intermediate solution” is used for convenience to distinguish the sodium sulfate Na₂SO₄ solution resulting from step 307 from the sodium sulfate Na₂SO₄ solution resulting from step 412 previously referred to as the “second intermediate solution.” However, it will also be understood that the sodium sulfate Na₂SO₄ solution resulting from steps 307 and 412 collectively may be referred to as the “second intermediate solution”, for the purpose of conveniently distinguishing them collectively from the “first intermediate solution” resulting from step 406. Or, in embodiments of the disclosure where step 412 is not performed, the sodium sulfate Na₂SO₄ solution resulting from step 307 may be referred to as the “second intermediate solution” for the purpose of conveniently distinguishing it from the “first intermediate solution” resulting from step 406.

At step 308, if battery-grade product is desired, then the obtained wet Li₂CO₃ cake is re-dissolved and, at step 308, is further purified by the CO₂ method as described in the prior art, namely, the aforementioned CO₂ method involves reacting Li₂CO₃ product with CO₂ to produce soluble LiHCO₃. Insoluble impurities, such as iron, magnesium, and calcium are removed from the solution. The CO₂ is then removed, such as by increasing the temperature of the solution, to precipitate pure Li₂CO₃.

After steps 308, the obtained wet Li₂CO₃ is dried. Magnetic impurity removal steps may be performed in some parts of the process to remove impurities from the Li₂CO₃. A micronizing step may be performed to reduce the Li₂CO₃ product to a desired particle size before final packing.

### CO₂ Circuit.

A purpose of the CO₂ circuit is to produce a CO₂ gas that is separated from a clean mixed source gas comprising CO₂ gas. The produced CO₂ gas may be used for reaction with the LiOH solution in step 307.

In embodiments as illustrated in FIG. 3, in step 700, the source gas may be a flue gas that is directed from a flue gas stream produced by combustion of a fossil fuel in kiln used to produce heat for calcination of α-spodumene to produce β-spodumene in step 300.

In addition or in the alternative, a skilled in the art would appreciate that in step 702, the source gas is a flue gas directed from a flue gas stream produced by combustion of a fossil fuel in a burner or other heating equipment used to produce heat for acid roasting of the β-spodumene in step 302. In addition or in the alternative, in step 704, the source gas is a flue gas produced by combustion of a fossil fuel for some other process, which may or may not be otherwise associated with the method for producing the lithium product. As a non-limiting example, the fossil filed may be combusted to produce heat to generate steam for use in the process. In addition or in the alternative, the source gas may be open air.

At step 706 of the CO₂ circuit, the source gas may be processed to produce a gas stream that has a CO₂ concentration that is higher than that of the source gas. In embodiments, the produced gas stream may be pure or substantially pure CO₂ gas, but the present limitation is not limited by any particular purity or concentration of CO₂ gas. Suitable equipment and processes are known in the art for separation of CO₂ gas from flue gas. Non-limiting examples include physical or chemical absorption-based methods (e.g., using monoethanolamine (MEA) solvent, caustic, ammonia solution), physical or chemical adsorption-based methods (e.g. using molecular sieves. activated carbon, metallic oxides), cryogenic methods, and membrane-based methods that rely on gas separation, or gas absorption phenomena, as known in the art. Non-CO₂ components of the flue gas may optionally be treated before being emitted to the atmosphere (as indicated by the label “To air” in FIG. 3), sequestered, or otherwise treated in some manner. The gas stream that is relatively high in CO₂ concentration may be directed to Li₂CO₃ for reaction with the LiOH solution in step 307. In other words, the captured CO₂ in step 706 from flue gas is converted or sequestered in lithium carbonate product in step 307.

Inter-Relationship of PLS Circuit, Li₂CO₃ Circuit with LiOH Circuit LiOH/Na₂SO₄ Separation Circuit and Na₂SO₄ Conversion Circuit.

In embodiments, and as illustrated in FIG. 3, the skilled in the art would appreciate that the PLS Circuit, LiOH/Na₂SO₄ Separation Circuit, Li₂CO₃ circuit, LiOH circuit, and Na₂SO₄ conversion circuit are inter-related to each other in at least the following aspects.

First, the LiOH circuit and Li₂CO₃ circuit both process the LiOH/Na₂SO₄ mixed solution produced by step 406. Accordingly, the LiOH produced by step 406 maybe selectively directed (e.g., by use of appropriate process flow equipment such as piping and valves) between the LiOH circuit and Li₂CO₃ circuit, and selectively vary the amount of each lithium product that is produced. The LiOH circuit and the Li₂CO₃ circuit may be selectively sized for certain production capacities for these lithium products. For example, all of the LiOH/Na₂SO₄ mixed solution produced by step 406 may be directed exclusively to the Li₂CO₃ circuit to produce Li₂CO₃ as the only lithium product. Alternatively, all of the LiOH/Na₂SO₄ mixed solution produced by step 406 may be directed exclusively to the LiOH circuit to produce LiOH—H₂O as the only lithium product. Alternatively, a first portion of the LiOH/Na₂SO₄ mixed solution produced by step 406 may be directed to the LiOH circuit to produce LiOH—H₂O as a primary lithium product, while a second portion of the LiOH/Na₂SO₄ mixed solution produced by step 406 may be directed to the Li₂CO₃ circuit to produce Li₂CO₃ as a secondary lithium product.

Second, in step 307, precipitation of Li₂CO₃ from the mixed solution produces a mother liquor in the form of a Na₂SO₄ solution. In embodiments, this Na₂SO₄ solution may be directed to the process of step 600 whereby this Na₂SO₄ solution, and the Na₂SO₄ solution, resulting from step 412 if any, is mixed with Ca(OH)₂ so that the Na₂SO₄ and the Ca(OH)₂ react to convert the Na₂SO₄ to CaSO₄ and NaOH. As previously noted, step 600 regenerates the NaOH “reaction fluid” for repeated use in continued performance or for its recycling it back into step 406 of the method.

Third, as previously described, a portion or all of the NaOH produced by step 600 may be used to treat the feed solution in the PLS purification process of step 304, and/or re-introduced or recycled back into the process for use in the LiOH conversion process of step 406.

In comparison to the prior art processes that are illustrated in FIGS. 1 and 2, a person skilled in the art would appreciate that, while having the benefit of the present disclosure, the method as shown in FIG. 3 has several advantages, such as, but not limited to the following:

First, the method may be capable of producing both Li₂CO₃ and LiOH—H₂O, or selectively one of Li₂CO₃ or LiOH—H₂O.

Second, by consuming CO₂ emissions from flue gases, the method reduces CO₂ emissions by effectively converting or sequestering them into the Li₂CO₃ product, realizing a real on-site conversion or sequestration of CO₂.

Third, by using CO₂ gas as a reactant, the method avoids the use of or reduces the amount of Na₂CO₃ reagent required for production of Li₂CO₃.

Fourth, by regenerating, re-using and re-cycling NaOH in a closed loop, the method reduces or even eliminate the amount of NaOH required for the production of LiOH. As noted above, only an initial amount of NaOH needs to be supplied as a reagent to start the process in the first instance of performing step 406.

Fifth, in comparison with known methods such as the one illustrated in FIG. 1, which uses Na₂CO₃ as a main reagent for Li₂CO₃ production and the method of FIG. 2, which uses NaOH as a main reagent for LiOH—H₂O production, in the present disclosure, Ca(OH)₂ effectively replaces both NaOH and Na₂CO₃ as the main reagent input for the combined production of both LiOH—H₂O product and Li₂CO₃ product.

Sixth, the method may also convert the relatively low value and low market demand intermediate product of Na₂SO₄ to a higher value and higher market demand byproduct such as Ca₂SO₄.

Seven, almost all of the Na₂SO₄ conversion reactions may be performed at room temperature and at ambient pressure and result in precipitation of a sulfate byproduct, thus reducing the need for expensive equipment, energy inputs for heating, or pressurization equipment, and other associated operating expenses. The reactions may be performed using low cost equipment, thus reducing capital expenses and operation cost.

Example No. 2: combined production of LiOH—H₂O as primary lithium product, Li₂CO₃ as a secondary lithium product by capture and conversion or sequestration of CO₂ from flue gas, as well as, production of CaSO₄ as a byproduct by reacting an intermediate byproduct Na₂SO₄ with an alkali chemical (Ca(OH)₂), and wherein a NaOH reaction fluid that is circulated in a closed-loop and re-used in the method, and all Na₂SO₄ is separated by the freezing separation method.

In this example, Li₂CO₃ is produced by CO₂ reacting with LiOH-PLS solution and in the absence of Na₂SO₄ mother liquor. All Na₂SO₄ is separated by freezing method.

In embodiments, and as illustrated in FIG. 4, there is provided a representation of a method of processing a material containing lithium, such as hard rock lithium minerals like α-spodumene, to produce a primary lithium product comprising lithium hydroxide monohydrate (LiOH—H₂O), a secondary lithium product comprising lithium carbonate (Li₂CO₃), and a sulfate byproduct such as calcium sulfate (CaSO₄). As with example 1 above, it will be understood that the terms “primary lithium product” and “secondary lithium product” are used for convenience to distinguish the products, and do not limit the present invention in terms of the relative amounts that are produced of each product, or the order by which they each can be produced. The amount of each product may be selectively varied.

In embodiments, as better seen in FIG. 4, Li₂CO₃ is produced by CO₂ reacting with LiOH PLS solution and in the absence of Na₂SO₄ mother liquor. Therefore, a person of ordinary skill in the art would understand that an embodiment as represented in FIG. 4 may include similar steps and circuits as those illustrated in FIG. 3 and explained in detail above, with the necessary adaptations, except that the Li₂CO₃ circuit is different.

In the Li₂CO₃ circuit, instead of using a mixed solution of LiOH/Na₂SO₄ from a PLS Circuit as described in the Example No. 1 and illustrated in FIG. 3, the input stream is a LiOH PLS solution from the LiOH/Na₂SO₄ Separation Circuit. Furthermore, there is no Na₂SO₄ produced, since all of the Na₂SO₄ is separated in step 408 by a freezing separation method, which directs the Na₂SO₄-10H₂O to a Na₂SO₄ conversion circuit as illustrated in steps 412 and 600.

In addition to the advantages with respect to Example No. 1 and as illustrated in FIG. 3, a person skilled in the art would appreciate that, while having the benefit of the present disclosure, the method as shown in FIG. 3 has several other advantages, such as, but not limited to the following. In an embodiment, all of the Na₂SO₄ may be separated in one step and in the solid form of Glauber's salt, thereby facilitating the process of producing the lithium product in accordance with the methods already described in detail. Moreover, the process is also simpler because no Na₂SO₄ is produced in the solution, given that the CO₂ reacts with the LiOH to produce Li₂CO₃, Furthermore, there is only one stream for the separation of the Na₂SO₄, which facilitates the process overall. Finally, the recovery of Lithium is more efficient in the embodiment illustrated in FIG. 4.

### Definitions

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

“Alkali chemical”, as used herein, refers to a chemical selected from the group consisting of calcium hydroxide (Ca(OH)₂), ammonium hydroxide (NH₄OH), barium hydroxide (Ba(OH)₂), potassium hydroxide (KOH), or mixtures of any of the foregoing.

“Flue gas”, as used herein, refers to a gas comprising CO₂ gas produced as an emission from the combustion of a fossil fuel. As non-limiting examples, flue gas may be CO₂ gas mixed with non-CO₂ gases such as water vapor, oxygen, carbon monoxide, nitrogen oxides, and sulfur oxide.

The expression “Feed solution”, as used herein, refers to an aqueous solution comprising Li₂SO₄ is produced by leaching of material produced by acid-roasting of β-spodumene, which is produced by calcination of α-spodumene concentrate. It will be understood that this is a non-limiting embodiment of how this “feed solution” may be produced, and that the present invention may be applied to such solutions formed by other processes, as described below.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of +5%, +10%, +20%, or +25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As used herein, the term “comprising” is intended to mean that the list of elements following the word “comprising” are required or mandatory but that other elements are optional and may or may not be present. As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used herein, the term “consisting of” is intended to mean including and limited to whatever follows the phrase “consisting of”. Thus, the phrase “consisting of” indicates that the listed elements are required or mandatory and that no other elements may be present.

It is noted that terms like “preferably”, “commonly”, “generally”, and “typically” are not utilized herein to limit the scope of the claimed invention or to imply that certain features are critical, essential, or even important to the structure or function of the claimed invention. Rather, these terms are merely intended to highlight alternative or additional features that can or cannot be utilized in a particular embodiment of the present invention.

For the purposes of describing and defining the present invention it is noted that the term “substantially” is utilized herein to represent the inherent degree of uncertainty that can be attributed to any quantitative comparison, value, measurement, or other representation. The term “substantially” is also utilized herein to represent the degree by which a quantitative representation can vary from a stated reference without resulting in a change in the basic function of the subject matter at issue.

The corresponding structures, materials, acts, and equivalents of all means or steps plus function elements in the claims appended to this specification are intended to include any structure, material, or act for performing the function in combination with other claimed elements as specifically claimed.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

1. A method of processing a lithium-containing material to produce a lithium product, the method comprising the steps of:
(a) preparing an aqueous feed solution comprising lithium sulfate by reacting the lithium-containing material with sulfuric acid;
(b) reacting the aqueous feed solution with a reagent selected from the group consisting of sodium hydroxide (NaOH), sodium carbonate (Na₂CO₃),
limestone powder (CaCO₃), lime (CaO), hydrated lime (Ca(OH)₂) and water (H₂O), and subjecting the aqueous feed solution to a solid/liquid separation to produce a first intermediate solution comprising lithium hydroxide and sodium sulfate;
(c) producing the lithium product, wherein producing the lithium product comprises the sub-step(s) of:
(i) separating a primary lithium product comprising the lithium hydroxide from a first portion of the first intermediate solution; or
(ii) reacting a second portion of the first intermediate solution with carbon dioxide to produce a secondary lithium product comprising lithium carbonate.

2. The method of claim 1, wherein the step (c) comprises producing a second intermediate solution comprising sodium sulfate from the first intermediate solution.

3. The method of claim 1 or 2, wherein the primary and secondary lithium products are simultaneously produced.

4. The method of any one of claims 1 to 3 comprising a step (d), the step (d) comprising:
(d) reacting the second intermediate solution comprising sodium sulfate with an alkali chemical to produce sodium hydroxide and a byproduct.

5. The method of claim 4, wherein the alkali chemical comprises calcium hydroxide and the byproduct comprises calcium sulfate; the alkali chemical comprises ammonium hydroxide and the byproduct comprises ammonium sulfate; the alkali chemical comprises barium hydroxide and the byproduct comprises barium sulfate; or the alkali chemical comprises potassium hydroxide and the byproduct comprises potassium sulfate.

6. The method of claim 4 or 5, wherein sodium hydroxide is reused in the step of (b) for continuing the reaction of the feed solution with sodium hydroxide to produce a first intermediate solution comprising lithium hydroxide and sodium sulfate, thereby producing the primary lithium product or the secondary lithium product, or both, and the byproduct.

7. The method of any one of claims 1 to 6, wherein step (c) comprises sub-step (i).

8. The method of any one of claims 2 to 7, wherein producing the second intermediate solution comprises: separating decahydrate of sodium sulfate from the first portion of the first intermediate solution; and dissolving the separated decahydrate of sodium sulfate in water.

9. The method of any one of claims 1 to 6, wherein step (b) comprises sub-step (ii).

10. The method of claim 9, wherein in sub-step (ii), the carbon dioxide is separated from a flue gas produced by combustion of a fossil fuel used to produce heat for sulfuric acid roasting of a mineral used to prepare the feed solution, or for a calcination process of a mineral used to prepare the feed solution, or for generating steam for use in the method.

11. The method of any one of claims 1 to 10, wherein the alkali chemical comprises calcium hydroxide, and the byproduct comprises calcium sulfate.

12. The method of any one of claims 1 to 11, wherein the lithium-containing material comprises a mineral.

13. The method of claim 12, wherein step (a) comprises sulfuric acid roasting the mineral to prepare an acid-roasted mineral.

14. The method of claim 12 or 13, wherein before step (a), the method comprises a step of subjecting the mineral to a calcination process for phase conversion of the mineral.

15. The method of any one of claims 12 to 14, wherein the mineral comprises spodumene.

16. The method of any one of claims 12 to 14, wherein the mineral comprises petalite, lepidolite, zinnwaldite, amblygonite, and eucryptite, hectorite, a lithium clay, or jadarite.

17. The method of any one of claims 1 to 16, wherein the lithium-containing material comprises lithium carbonate.

18. The method of any one of claims 1 to 17, wherein the lithium-containing material comprises material from a used battery.

19. The method of claim 1, wherein the step (c) of producing a lithium product comprises the sub-steps (iii) and (iv), in the absence of sub-steps (i) or (ii), the sub-step(s) (iii) and (iv) comprising:
(iii) subjecting the first intermediate solution comprising lithium hydroxide and sodium sulfate to freezing, thereby separating the lithium hydroxide from the sodium sulfate; and
(iv) reacting the carbon dioxide with lithium hydroxide to produce the secondary lithium product comprising lithium carbonate.

20. A method of processing an aqueous feed solution comprising lithium sulfate to produce a lithium product, the method comprising the steps of:
(a) subjecting the aqueous feed solution to a solid/liquid separation, and reacting the aqueous feed solution with sodium hydroxide to produce a first intermediate solution comprising lithium hydroxide and sodium sulfate;
(b) producing the lithium product wherein producing the lithium product comprises the sub-step(s) of:
(i) separating a primary lithium product comprising the lithium hydroxide from at least a first portion of the first intermediate solution; or
(ii) reacting a second portion of the first intermediate solution with carbon dioxide to produce a secondary lithium product comprising lithium carbonate.

21. The method of claim 20, wherein the step (b) comprises producing a second intermediate solution comprising sodium sulfate from the first intermediate solution.

22. The method of claim 20 or 21, wherein the primary and secondary lithium products are simultaneously produced.

23. The method of any one of claims 20 to 22 comprising a step (c), wherein the step (c) comprises:
(c) reacting the second intermediate solution comprising sodium sulfate with an alkali chemical to produce sodium hydroxide and a byproduct, wherein either: the alkali chemical comprises calcium hydroxide and the byproduct comprises calcium sulfate; the alkali chemical comprises ammonium hydroxide and the byproduct comprises ammonium sulfate; the alkali chemical comprises barium hydroxide and the byproduct comprises barium sulfate; or the alkali chemical comprises potassium hydroxide and the byproduct comprises potassium sulfate.

24. The method of claim 23, wherein sodium hydroxide is reused in the step of (a) for continuing the reaction of the feed solution with sodium hydroxide to produce a first intermediate solution comprising lithium hydroxide and sodium sulfate, thereby producing the primary lithium product or the secondary lithium product, or both, and the byproduct.

25. The method of any one of claims 20 to 24, wherein step (b) comprises sub-step (i).

26. The method of any one of claims 21 to 24, wherein producing the second intermediate solution comprises: separating decahydrate of sodium sulfate from the first portion of the first intermediate solution; and dissolving the separated decahydrate of sodium sulfate in water.

27. The method of any one of claims 20 to 24, wherein step (b) comprises sub-step (ii).

28. The method of claim 27, wherein in sub-step (ii), the carbon dioxide is separated from a flue gas produced by combustion of a fossil fuel used to produce heat for sulfuric acid roasting of a mineral used to prepare the feed solution, or for a calcination process of a mineral used to prepare the feed solution, or for generating steam for use in the method.

29. The method of any one of claims 23 to 28, wherein the alkali chemical comprises calcium hydroxide, and the byproduct comprises calcium sulfate.

30. The method of any one of claims 20 to 29, wherein before step (a), the method comprises, a step of preparing the aqueous feed solution by reacting a lithium-containing material with sulfuric acid.

31. The method of claim 30, wherein the lithium-containing material comprises a mineral.

32. The method of claim 30 or 31, wherein reacting the lithium-containing material with sulfuric comprises sulfuric acid roasting the mineral to prepare an acid-roasted mineral.

33. The method of claim 31 or 32, wherein the method comprises, before reacting the mineral with sulfuric acid, a step of subjecting the mineral to a calcination process for phase conversion of the mineral.

34. The method of any one of claims 31 to 33, wherein the mineral comprises spodumene.

35. The method of any one of claims 31 to 34, wherein the mineral comprises petalite, lepidolite, zinnwaldite, amblygonite, and eucryptite, hectorite, a lithium clay, or jadarite.

36. The method of any one of claims 30 to 35, wherein the lithium-containing material comprises a lithium carbonate.

37. The method of any one of claims 30 to 36, wherein the lithium-containing material comprises material from a battery material from battery recycling.

38. The method of claim 20, wherein the step (b) of producing a lithium product comprises the sub-steps (iii) and (iv), in the absence of sub-steps (i) or (ii), the sub-step(s) (iii) and (iv) comprising:
(iii) subjecting the first intermediate solution comprising lithium hydroxide and sodium sulfate to freezing, thereby separating the lithium hydroxide from the sodium sulfate; and
(iv) reacting the carbon dioxide with lithium hydroxide to produce the secondary lithium product comprising lithium carbonate.

39. A method of processing a lithium-containing material to produce a first primary lithium product of lithium hydroxide and a secondary lithium product comprising lithium carbonate, the method comprising the steps of:
(a) preparing an aqueous feed solution comprising lithium sulfate by reacting the lithium-containing material with sulfuric acid;
(b) reacting the feed solution with sodium hydroxide to produce a first intermediate solution comprising lithium hydroxide and sodium sulfate;
(c) separating the primary lithium product comprising lithium hydroxide from a first portion of the first intermediate solution comprising lithium hydroxide and sodium sulfate; and
(d) reacting a second portion of the first intermediate solution with carbon dioxide to produce the secondary lithium product comprising lithium carbonate.

40. The method of claim 39, wherein either step (c) or step (d), or both of them, comprises producing a second intermediate solution comprising sodium sulfate from the first intermediate solution, and the method comprises the further steps of:
(e) reacting the second intermediate solution comprising sodium sulfate with an alkali chemical to produce sodium hydroxide and a byproduct, wherein either: the alkali chemical comprises calcium hydroxide and the byproduct comprises calcium sulfate; the alkali chemical comprises ammonium hydroxide and the byproduct comprises ammonium sulfate; the alkali chemical comprises barium hydroxide and the byproduct comprises barium sulfate; or the alkali chemical comprises potassium hydroxide and the byproduct comprises potassium sulfate; and
(f) repeating steps (b) to (e), wherein the sodium hydroxide produced in step (e) is used when repeating step (b).

41. The method of claim 40, wherein the alkali chemical comprises calcium hydroxide, and the byproduct comprises calcium sulfate.

42. The method of any one of claims 39 to 41, wherein in step (c), producing the second intermediate solution comprises the sub-steps of: separating decahydrate of sodium sulfate from the first portion of the first intermediate solution; and dissolving the separated decahydrate of sodium sulfate in water to produce the second intermediate solution comprising sodium sulfate.

43. The method of any one of claims 39 to 42, wherein the carbon dioxide is separated from a flue gas produced by combustion of a fossil fuel used to produce heat for sulfuric acid roasting of a mineral used to prepare the feed solution, or for a calcination process of a mineral used to prepare the feed solution, or for generating steam for use in the method.

44. The method of any one of claims 39 to 43, wherein the lithium-containing material comprises a mineral.

45. The method of any one of claims 39 to 43, wherein reacting the lithium-containing material with sulfuric comprises sulfuric acid roasting the mineral to prepare an acid-roasted mineral.

46. The method of any one of claims 39 to 45, wherein before the step of reacting the mineral with sulfuric acid, the method comprises a step of subjecting the mineral to a calcination process for phase conversion of the mineral.

47. The method of any one of claims 44 to 46, wherein the mineral comprises spodumene.

48. The method of any one of claims 44 to 47, wherein the mineral comprises petalite, lepidolite, zinnwaldite, amblygonite, and eucryptite, hectorite, a lithium clay, or jadarite.

49. The method of any one of claims 39 to 48, wherein the lithium-containing material comprises a lithium carbonate.

50. The method of any one of claims 39 to 48, wherein the lithium-containing material comprises material from a battery material from battery recycling.

51. The method of claim 39, wherein before the steps (c) and (d), producing a lithium product comprises the step (h), the step (h) comprising the sub-step(s) (i) and (ii) in the absence of the steps (c) and (d);
(i) subjecting the first intermediate solution comprising lithium hydroxide and sodium sulfate to freezing, thereby separating the lithium hydroxide from the sodium sulfate; and
(ii) reacting the carbon dioxide with lithium hydroxide to produce the secondary lithium product comprising lithium carbonate.

52. A method of processing an aqueous feed solution comprising lithium sulfate to produce a first primary lithium product of lithium hydroxide and a secondary lithium product comprising lithium carbonate, the method comprising the steps of:
(a) reacting the feed solution with sodium hydroxide to produce a first intermediate solution comprising lithium hydroxide and sodium sulfate;
(b) separating the primary lithium product comprising lithium hydroxide from a first portion of the first intermediate solution comprising lithium hydroxide and sodium sulfate; and
(c) reacting a second portion of the first intermediate solution with carbon dioxide to produce the secondary lithium product comprising lithium carbonate.

53. The method of claim 52, wherein either step (b) or step (c), or both of them, comprises producing a second intermediate solution comprising sodium sulfate from the first intermediate solution, and the method comprises the steps of:
(d) reacting the second intermediate solution comprising sodium sulfate with an alkali chemical to produce sodium hydroxide and a byproduct, wherein either: the alkali chemical comprises calcium hydroxide and the byproduct comprises calcium sulfate; the alkali chemical comprises ammonium hydroxide and the byproduct comprises ammonium sulfate; the alkali chemical comprises barium hydroxide and the byproduct comprises barium sulfate; or the alkali chemical comprises potassium hydroxide and the byproduct comprises potassium sulfate; and
(e) repeating steps (a) to (d), wherein the sodium hydroxide produced in step (d) is used when repeating step (a).

54. The method of claim 53, wherein the alkali chemical comprises calcium hydroxide, and the byproduct comprises calcium sulfate.

55. The method of claim 53 or 54, wherein in step (b), producing the second intermediate solution comprises the sub-steps of: separating decahydrate of sodium sulfate from the first portion of the first intermediate solution; and dissolving the separated decahydrate of sodium sulfate in water to produce the second intermediate solution comprising sodium sulfate.

56. The method of any one of claims 53 to 55, wherein the carbon dioxide is separated from a flue gas produced by combustion of a fossil fuel used to produce heat for sulfuric acid roasting of a mineral used to prepare the feed solution, or for a calcination process of a mineral used to prepare the feed solution, or for generating steam for use in the method.

57. The method of any one of claims 53 to 56, wherein before step (a), the method comprises a step of preparing the aqueous feed solution by reacting a lithium-containing material with sulfuric acid.

58. The method of claim 57, wherein the lithium-containing material comprises a mineral.

59. The method of claim 57 or 58, wherein reacting the lithium-containing material with sulfuric comprises sulfuric acid roasting the mineral to prepare an acid-roasted mineral.

60. The method of any one of claims 57 to 59, wherein before reacting the mineral with sulfuric acid, the method comprises a step of subjecting the mineral to a calcination process for phase conversion of the mineral.

61. The method of any one of claims 58 to 60, wherein the mineral comprises spodumene.

62. The method of anyone of claims 58 to 61, wherein the mineral comprises petalite, lepidolite, zinnwaldite, amblygonite, and eucryptite, hectorite, a lithium clay, or jadarite.

63. The method of any one of claims 57 to 62, wherein the lithium-containing material comprises a lithium carbonate.

64. The method of any one of claims 57 to 63, wherein the lithium-containing material comprises material from a battery material from battery recycling.

65. The method of claim 52, wherein before the steps (b) and (c), producing a lithium product comprises the step (f), the step (f) comprising the sub-step(s) (i) and (ii) in the absence of the steps (b) and (c);
(i) subjecting the first intermediate solution comprising lithium hydroxide and sodium sulfate to freezing, thereby separating the lithium hydroxide from the sodium sulfate; and
(ii) reacting the carbon dioxide with lithium hydroxide to produce the secondary lithium product comprising lithium carbonate.
